(19) United States
(12) Patent Application Publication
(10) Pub. No.: US 2011/0204584 A1
(43) Pub. Date: Aug. 25, 2011

(54) INSTALLATION APPARATUS FOR STEPS AND HOOKS AND RELATED METHODS

(75) Inventors: William C. Watts, Keokuk, IA (US); Ronald C. Bricker, Macomb, IL (US)

(73) Assignee: AMPRO MANUFACTURING, INC., Keokuk, IA (US)

(21) Appl. No.: 12/710,020

(22) Filed: Feb. 22, 2010

(51) Int. Cl. B25F 3/00; B23B 51/12; B23B 31/10

(52) U.S. Cl. 279/145; 408/239 A; 29/428

(57) ABSTRACT

A drill insert is provided for coupling a step or hook to a structure. The insert has a gripping portion configured to engage the step or hook, and a supporting portion. The supporting portion has an interior channel for slidably receiving the gripping portion and an elongate end that is configured for insertion into the chuck of a drill and which extends along a longitudinal axis. The gripping and supporting portions are slideable relative to one another along the longitudinal axis, with selective sliding motion between the gripping and supporting portions being effective to selectively lock and release the step or hook relative to the insert.

### TECHNICAL FIELD

This invention is generally related to apparatuses for installing steps or hooks to a structure and, more particularly, to apparatuses for installing a step to a tree.

### BACKGROUND

During hunting season, hunters attempt to gain certain advantages over their prey, as well as advantages over other hunters hunting the same prey. For example, certain advantages may be gained to a bow hunter that is perched well above the ground in comparison to a bow hunter perched in a ground-based location. More specifically, because of natural obstructions near the ground, target angles may be more advantageous when the hunter is elevated. Moreover, a higher elevation also facilitates avoiding early detection of the hunter by prey on the ground.

It is therefore common for hunters to hunt from tree stands that are secured within trees at various heights above the ground. In order to facilitate providing the required means for climbing the tree, some hunters are known to use a self-tapping hook, commonly referred to as a tree step. At least some known tree steps are characterized by a threaded portion that is inserted into the tree. While some of these tree steps are designed to be manually coupled to the tree, for example by manually rotating a foot peg portion of the tree step, in some cases, depending upon the density of the material to which the tree step is being coupled, a relatively high amount of rotational force may be required for coupling the tree step to the tree. Further, it is sometimes necessary to pre-form (e.g., hammer-puncture, pre-drill) a hole in the tree such that rotation of the tree step results in coupling of the tree step to the tree.

In such cases, a driving tool may be used to couple the tree step to the tree. Conventional driving tools developed for such purpose include, for example, a drill to which a portion of the tree step is temporarily coupled, such that actuation of the drill results in rotation of the tree step, which in turn couples the tree step to the tree. The use of such driving tools to install the tree step, however, may require the use of both of the hunter's hands, which may be inconvenient to the hunter, especially when the hunter is already resting above ground. Conventional tools may include hingedly mounted latches or fasteners (e.g., screws, bolts, knobs) that have to be rotated with one hand while holding the rest of the driving tool and tree step with the other hand, in order to secure the tree step to the tool. Moreover, conventional tools may include non-metallic components which, in the hunting environment, may tend to fail (e.g., break).

It would be desirable, therefore, to provide apparatuses and related methods that facilitate the coupling of tree steps or hooks to a structure such as a tree, and which addresses these and other problems associated with conventional apparatuses designed for that purpose.

### SUMMARY

In one embodiment, a drill insert is provided for coupling a step or hook to a structure. The insert has a gripping portion configured to engage the step or hook, and a supporting portion. The supporting portion has an interior channel for slidably receiving the gripping portion, and an elongate end that is configured for insertion into the chuck of a drill and which extends along a longitudinal axis. The gripping and supporting portions are slideable relative to one another along the longitudinal axis, with selective sliding motion between the gripping and supporting portions being effective to selectively lock and release the step or hook relative to the insert. The insert may include a depression in one of the gripping or supporting portions, and a détente that is selectively received within the depression for restricting movement of the gripping and supporting portions relative to one another.

In a specific embodiment, a biasing member urges the détente toward the depression. Alternatively or additionally, the insert may include a retaining element in one of the gripping or supporting portions. The insert may also have a pair of spaced confronting surfaces in the other of the gripping or supporting portions, with the extent of the sliding motion of the gripping and supporting portions relative to one another corresponding to engagement of the retaining element with the spaced confronting surfaces. Additionally or alternatively, the retaining element may be positioned so as to prevent decoupling of the gripping and supporting portions from one another.

The insert may include a ramp in the other of the gripping or supporting portions and which is positioned for engagement with the retaining element, with movement of the retaining element along the ramp being effective to tighten the grip of the step or hook by the insert. The retaining element, in a specific embodiment, is a pin. The pin may extend along a pin axis, with such pin axis being spaced from the longitudinal axis of the insert. The gripping portion may include a first notch that is configured to receive the step or hook therein and which may be oriented so as to receive the step or hook in a direction transverse to the longitudinal axis.

Additionally or alternatively, the supporting portion may include a second notch that cooperates with the first notch to substantially surround a cross-section of the step or hook so as to restrict movement of the step or hook, relative to the insert, in two directions along the longitudinal axis. The supporting portion may include a third notch that is spaced from the second notch and which cooperates with the first and second notches to restrict movement of the step or hook, relative to the insert, in a direction that is transverse to the longitudinal axis. The insert may be free of rotatable fasteners. The insert may also be free of non-metallic components.

In a specific embodiment, a pin extends in the interior channel of the supporting portion and is positioned to engage the gripping portion at spaced surfaces to prevent decoupling of the gripping and supporting portions from one another. In that embodiment, a ramp is located in the gripping portion between the spaced surfaces and is positioned for engagement with the pin, with movement of the pin along the ramp being effective to tighten the grip of the step or hook by the insert. Additionally or alternatively, the insert may have a depression in a surface of the interior channel of the supporting portion, and a détente in the gripping portion is urged toward that surface of the interior channel by a biasing member and is engageable with the depression. The détente in that embodiment is adapted to restrict the sliding motion of the gripping and supporting portions when engaged in the depression.

In another embodiment, an apparatus is provided for coupling a step or hook to a structure. The apparatus includes a drill having a chuck, and an insert that has a gripping portion configured to engage the step or hook and a supporting portion. The supporting portion has an interior channel for slidably receiving the gripping portion, and an elongate end extending along a longitudinal axis and configured for insertion into the chuck. The gripping and supporting portions are slideable relative to one another along the longitudinal axis of the insert, with selective sliding motion between the gripping and supporting portions being effective to selectively lock and release the step or hook relative to the insert.

In yet another embodiment, a method is provided for coupling a step or hook to a structure. The method includes coupling an elongate end of an insert into a chuck of a drill, with the insert having a gripping portion and a supporting portion having the elongate end and an interior channel slidably receiving the gripping portion opposite the elongate end. The gripping portion is slidable along a longitudinal axis between an extended position and a retracted position. The method includes engaging the step or hook in the gripping portion while in the extended position and sliding the gripping and supporting portions of the insert relative to one another to the retracted position to lock the step or hook relative to the insert.

The method may include moving a pin in the interior channel of the supporting portion along a ramp of the gripping portion to thereby tighten grip of the step or hook by the insert in a direction transverse to the longitudinal axis. Additionally or alternatively, the method may include engaging an outwardly biased détente of the gripping portion with a depression of the supporting portion to thereby restrict slidable movement of the gripping and supporting portions relative to one another from the retracted position.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an apparatus for coupling tree steps or hooks to a structure in accordance with one embodiment of the invention.

FIG. 2 is a perspective view of a drill insert of the apparatus of FIG. 1.

FIG. 3A is a cross-sectional view taken generally along line 3-3 of FIG. 2.

FIG. 3B is a view similar to FIG. 3A showing gripping and supporting portions of the drill insert in respective positions different from those illustrated in FIG. 3A.

FIG. 4A is a cross-sectional view taken generally along line 4-4 of FIG. 2.

FIG. 4B is a view similar to FIG. 4A showing the gripping and supporting portions of the drill insert in respective positions different from those illustrated in FIG. 4A.

### DETAILED DESCRIPTION

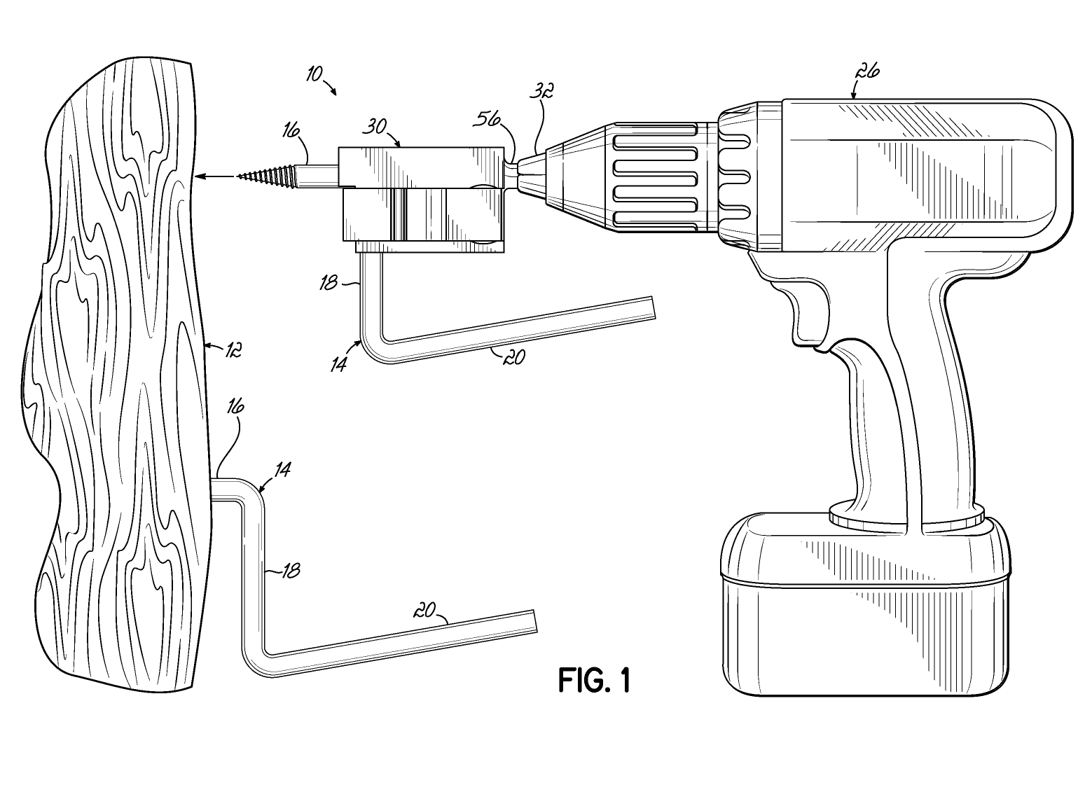

With respect to the figures and, particularly, to FIG. 1, an apparatus 10 is illustrated for coupling a hook to a structure such as a wall or a tree 12, for example, as illustrated in the figure. The hook may, for example, take the form of a tree step 14 which facilitates climbing of a tree 12 by a user such as a hunter. In this regard, the tree step 14 has a first, generally horizontal segment 16, having a threaded end, and the rotation of which taps the tree 12, thereby resulting in threaded coupling of the tree step 14 to the tree 12. While the description herein refers to a tree step 14 for coupling to a tree 12, it is contemplated that the apparatuses and methods described herein may also be used to couple other hooks or similarly-shaped objects and be used to couple those to structures other than trees. For example, and without limitation, the apparatuses and methods herein described may be used to couple a bicycle hook or a ladder hook onto a wall or ceiling. The tree step 14 illustrated in FIG. 1 further includes a generally vertically-oriented second segment 18 and a slightly inclined foot peg segment 20 that supports a foot of the user (e.g., a hunter) during climbing of the tree 12. The foot peg segment 20 is offset from the first segment 16, to thereby define a general Z-shape of the tree step 14.

The apparatus 10 includes a drill 26, which may, without limitation, be a powered drill and may additionally be a cordless powered drill, and an insert 30 that is partially received within a chuck 32 of the drill 26. The insert 30 is configured to be secured in the chuck 32 of the drill 26 in conventional ways and is further configured to engage the tree step 14 such that, when the drill 26 is actuated, the tree step 14, and, in particular, the threaded first segment 16, is rotated into coupling engagement with the tree 12. As discussed in further detail below, the design of the insert 30 allows the user to selectively engage and lock the tree step 14 relative to the apparatus 10 (particularly relative to the insert 30) via a simple, single-handed operation. The design of the insert 30 also allows the user to unlock the tree step 14 relative to the apparatus 10 via a single-handed operation.

The illustrated embodiment, additionally, permits selectively locking and unlocking the tree step 14 relative to the apparatus 10 without the use of any rotational elements, such as hingedly-mounted latches, or rotatable fasteners such as bolted knobs, bolts, or screws, which may require the use of both hands, i.e., utilizing one hand to support the drill, driving tool, and tree step, and the other hand to turn the fastener to lock (or unlock) the tree step 14 in place. Moreover, all functional components of the exemplary insert 30, which are described in detail below, are made of suitably chosen strong materials, such as metal, which minimize the likelihood of failure (e.g., fracture) of such components during use. This may be particularly desirable in the hunting environment, for example, where the apparatus 10 may be exposed to less-than-ideal storage and/or in-use forces.

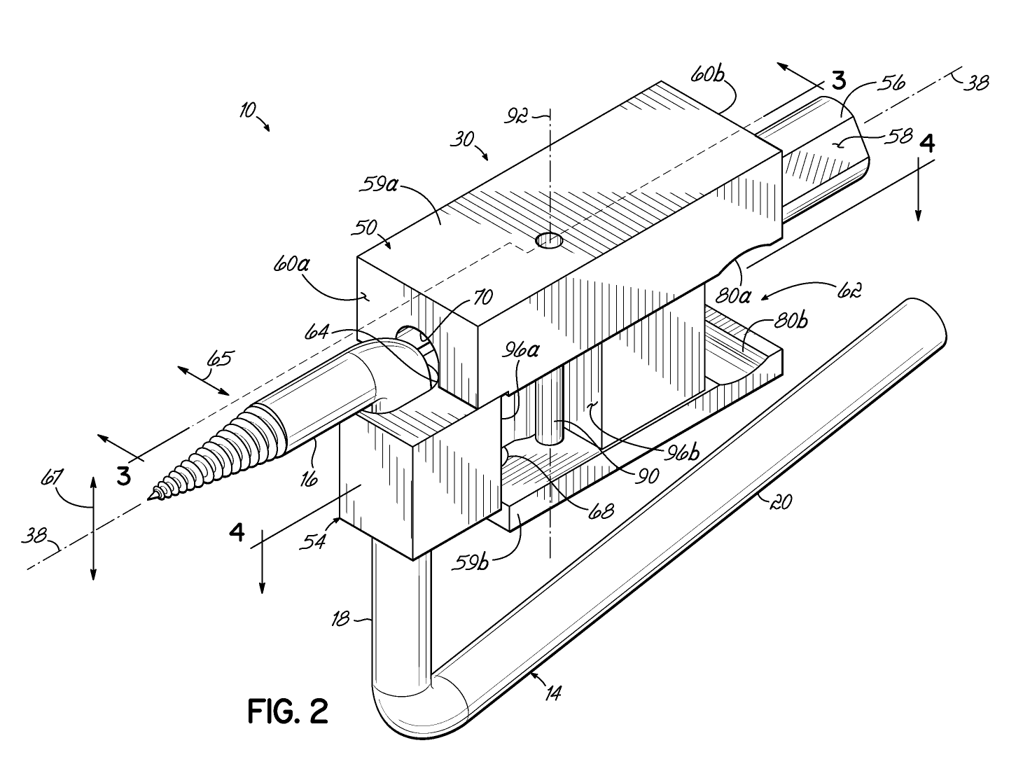

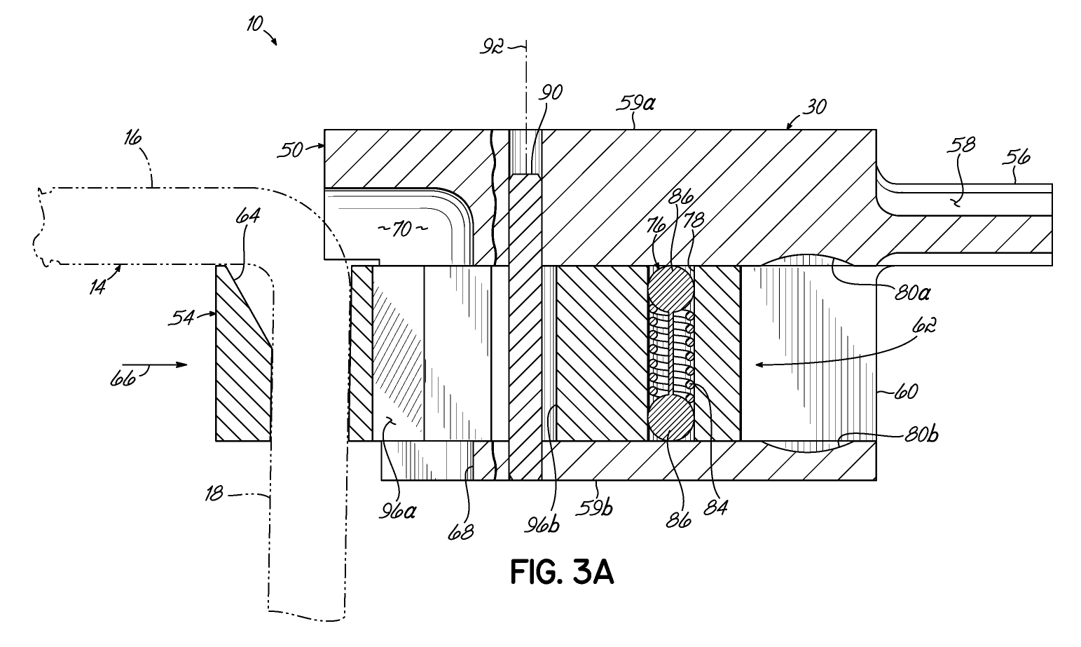

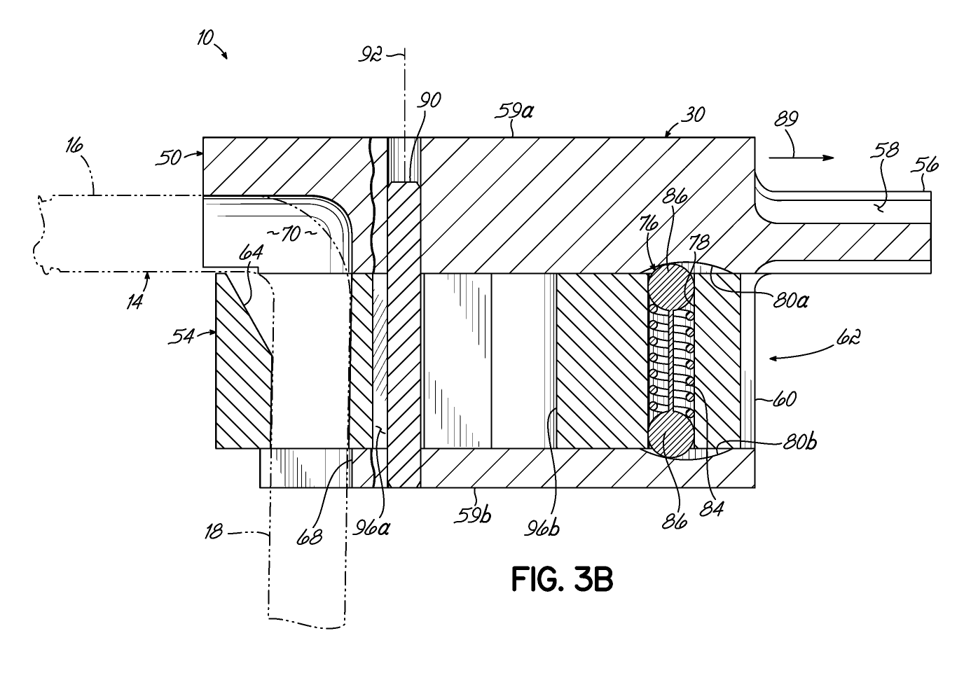

With continued reference to FIG. 1, and further referring to FIG. 2, insert 30 extends along a longitudinal axis 38 and includes a supporting portion 50 and a gripping portion 54 that are slidably movable relative to one another so as to position the gripping portion 54 in either an extended position or a retracted position relative to the supporting portion 50, as will be more fully described below. The supporting portion 50 includes a proximal, elongate end portion 56 that extends along the axis 38 and which is suitably shaped and sized to be received and secured within the chuck 32. In this regard, the end portion 56 may have a generally circular cross-section or may include one or more flat sections 58 that facilitate securing the insert 30 within the chuck 32 during rotation. The supporting portion 50 has opposed top and bottom legs 59a, 59b, a connecting portion 60 (FIGS. 3A, 3B) connecting the legs 59a, 59b, and an interior channel or slot 62 that slidably receives the gripping portion 54. Jointly, the legs 59a, 59b, portion 60, and slot 62 define a general C-shaped cross-section of the insert 30.

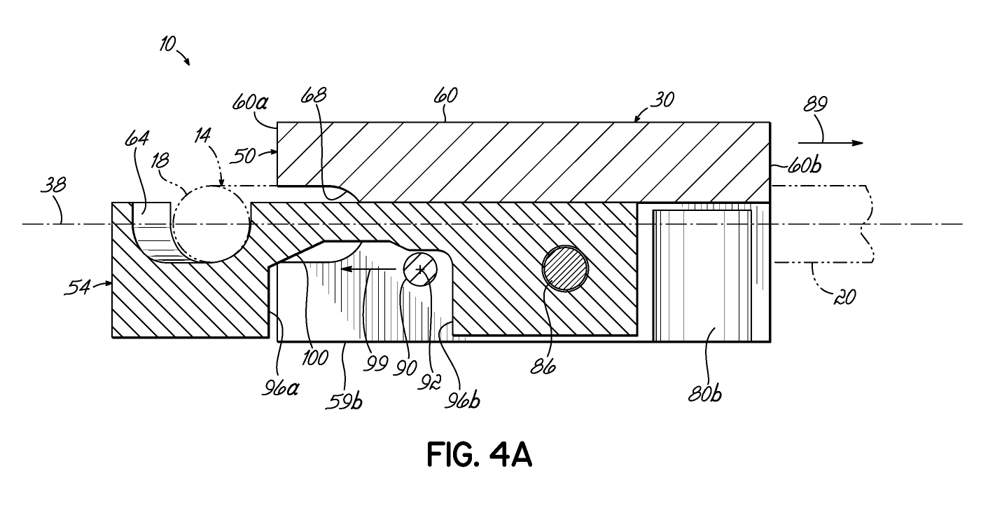

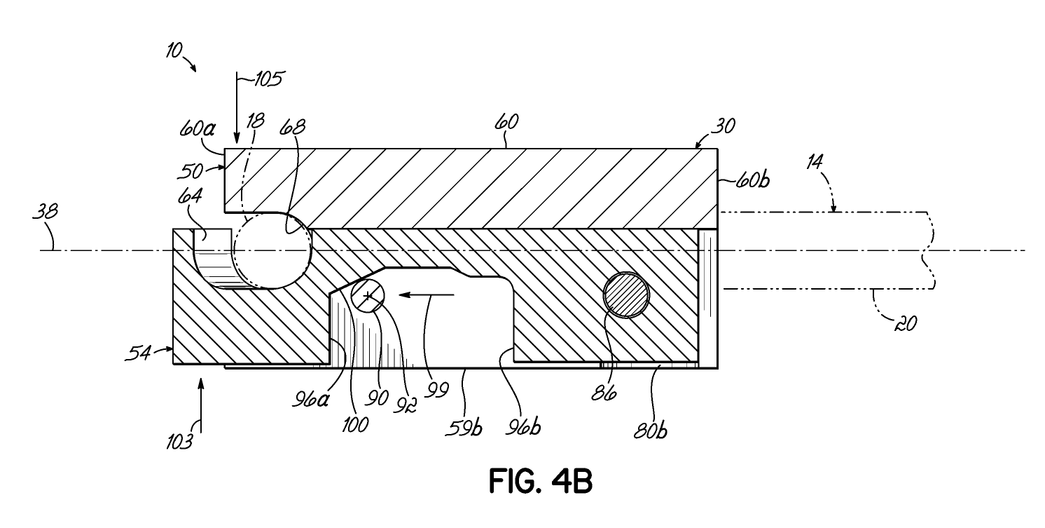

With continued reference to FIGS. 1 and 2, and further referring to FIGS. 3A-3B and 4A-4B, the gripping portion 54 is configured to grip the tree step 14 and, in the illustrated embodiment, includes a U-shaped first notch 64 that selectively receives the second segment 18 of the tree step 14 at a location adjacent the first segment 16, as illustrated in FIG. 2. The first notch 64 receives the tree step 14 in a direction transverse to the axis 38, such as the direction denoted by arrow 65. In use, the user secures the end portion 56 within the chuck 32 in a conventional manner, and engages the second segment 18 of the tree step 14 so as to be received within the first notch 64 of gripping portion 54, as best shown in the substantially extended position in FIGS. 2, 3A, and 4A. The user then slidably moves the gripping portion 54 relative to the supporting portion 50 (arrow 66) along the slot 62, causing the second segment 18 to be received within a second U-shaped notch 68 at the bottom leg 59b of supporting portion 50, as best shown in the substantially retracted position in FIGS. 3B and 4B. Jointly, the first and second notches 64, 68 substantially surround the cross-section of the second segment 18, which secures the tree step 14 relative to the insert 30 and restricts relative movement of the tree step 14 in both directions, forward and backward, along the axis 38. As used herein, the term “substantially,” when referring to the surrounding of the cross-section of the second segment 18, refers to surrounding about ¾ of the perimeter of such cross-section, as illustrated in FIG. 4B, for example.

The slidable, retracting movement of the gripping portion 54 also causes the first segment 16 of tree step 14 to be received along a U-shaped notch or channel 70 of top leg 59a of supporting portion 50. Third notch 70 further restricts relative movement of the tree step 14. Specifically, the third notch 70 restricts movement of the tree step 14 in a direction transverse and, in this embodiment, orthogonal to the axis 38 such as the direction denoted by arrow 67.

The spaced locations of the first and second notches 64, 68 of the gripping portion 54 also restrict rotational movement of the tree step 14. Specifically, by engaging the tree step 14 at two spaced locations along the length of the second segment 18, the insert 30 prevents rotation of the tree step 14, relative to the apparatus 10, in the plane defined by the second segment 18. Accordingly, any rotation of the tree step 14 during installation of the step 14 is solely attributable to actuation of the drill 26, which enhances control of the movement of tree step 14 during such installation.

In the locked or retracted condition of the tree step 14, as illustrated in FIGS. 3B and 4B, for example, the first segment 16 of the tree step 14 is substantially coaxial with the elongate end portion 56 i.e., the first segment 16 is held by the insert 30 so as to extend along axis 38. This type of arrangement of first segment 16 within insert 30 results in rotation of the tree step 14 about axis 38, which is also the axis of rotation of insert 30. This type of rotation enhances the single-handed operation of the apparatus 10, by restricting rotation of the tree step 14 and rotation of the insert 30 about a single, common axis 38. Coaxiality of the elongate end portion 56 and the first segment 16 of the tree step 14 is further facilitated by the notches 64, 68 and 70, which effectively function to guide the first segment 16 into a specific orientation relative to insert 30, which thereby facilitates attainment of such coaxiality.

With continued reference to FIGS. 1, 2, 3A-3B, and 4A-4B, insert 30 includes several features to enhance selective locking and release of the tree step 14 relative to the apparatus 10 and facilitate the single-handed operation of the apparatus 10. One of those features is a détente 76, which is supported within a channel 78 extending through the entire width of the gripping portion 54. In use, the détente 76 engages a cooperating structure in the form of a pair of depressions 80a, 80b located along the slot 62 at a proximal end portion of the supporting portion 50. More specifically, the détente 76 includes a biasing element, which in the illustrated embodiment takes the form of a compression spring 84, and a pair of engaging elements, such as balls 86, which are located at opposite ends of the spring 84. The spring 84 urges the balls 86 outward such that, when the gripping portion 54 is in the substantially retracted position (FIGS. 3B, 4B), each of the balls 86 is in frictional engagement with a respective one of the depressions 80a, 80b. This frictional engagement restricts slidable movement of the supporting and gripping portions 50, 54 relative to one another, thereby locking the tree step 14 in place, relative to the insert 30.

The curved shape of the exemplary depressions 80a, 80b of the illustrated embodiment provide a relatively smooth transition between the substantially extended and substantially retracted positions of the gripping portion 54 relative to the supporting portion 50 (FIGS. 3A, 4A and FIGS. 3B, 4B, respectively). This smooth transition further facilitates the single-handed operation of the apparatus 10 and is also available to the user once the tree step 14 is fully coupled to the tree 12 (FIG. 1). More specifically, once the tree step 14 is securely coupled to the tree 12, the user retracts the drill 26, which results in proximal movement (arrow 89) of the supporting portion 50. This proximal movement of the supporting portion 50 causes the balls 86 to ride along the curved depressions 80a, 80b. This movement compresses the spring 84 and forces the balls 86 into the channel 78, thereby facilitating further relative movement of the supporting and gripping portions 50, 54 toward the substantially extended position (FIGS. 2, 3A, 4A).

Those of ordinary skill in the art will readily appreciate that the described apparatus 10 may additionally or alternatively have other types of features restricting relative movement of the supporting and gripping portions 50, 54 in the substantially retracted position (FIGS. 3B, 4B) or include no such features at all, and still fall within the scope of the present disclosure. In one contemplated variation, for example, the apparatus 10 may instead include a détente having a single engaging element (e.g., ball 86) rather than two such elements, and which may be engageable with a single depression that may have a shape different from that of the illustrated depressions 80a, 80b. In such exemplary variation, the single engaging element may instead be engageable with a different type of cooperating structure and is thus not limited to depressions along the surface of the channel or slot 62. In addition, the one or more engaging elements may be associated with the supporting portion 50 and the cooperating structure may be formed in the gripping portion 54, thereby having an opposite configuration from that shown.

Insert 30 also includes a retaining element that prevents full disengagement between the supporting and gripping portions 50, 54 from one another. In the illustrated embodiment, the retaining element takes the form of a pin 90, which extends along a pin axis 92 that is offset (i.e., spaced) from the axis 38 of insert 30, as illustrated in FIG. 4A. The pin 90 extends across the entire width of the slot 62 (i.e., a dimension orthogonal to the axis 38 of insert 30) and is positioned to engage a pair of spaced, confronting inner wall surfaces 96a, 96b of the gripping portion 54 during relative movement of the supporting and gripping portions 50, 54 between the substantially retracted (FIGS. 3B, 4B) and substantially extended (FIGS. 3A, 4A) positions. In this regard, engagement of the pin 90 with the inner wall surfaces 96a, 96b determines the extent of the movement (parallel to axis 38) of the supporting and gripping portions 50, 54 relative to one another. More specifically, the pin 90 restricts any further relative movement of the supporting and gripping portions 50, 54 beyond the fully retracted and fully extended positions i.e., the positions corresponding to engagement of pin 90 with inner wall surfaces 96b and 96a, respectively. Moreover, pin 90 obstructs any movement of gripping portion 54 in a direction away from connecting portion 60 of supporting portion 50 (arrow 65) and connecting portion 60, in turn, limits movement of gripping portion 54 in the opposite direction (arrow 65). Accordingly, the pin 90 and the connecting portion 60 jointly prevent decoupling of the supporting and gripping portions 50, 54 from one another, thereby making insert 30 an integral, single device that does not require assembly in the field prior to being used. It may be understood that an opposite configuration is also contemplated, in which the retaining element (e.g., pin 90) resides in the gripping portion 54 and the confronting inner wall surfaces (96a, 96b) are formed in the supporting portion 50.

Pin 90 also facilitates tightening the grip of tree step 14 by the apparatus 10. Specifically, as the gripping portion 54 moves toward the fully retracted position, any external force exerted by the user toward the tree 12 (arrow 99) causes the pin 90 to engage and ride along a cam or ramp 100 of the gripping portion 54. The ramp 100 is oriented such that further movement of the pin 90 in the direction of arrow 99 moves the gripping portion 54 laterally (i.e., transverse to the axis 38, as in the direction denoted by arrow 103) relative to the supporting portion 50, which causes the first and second notches 64, 68 to tighten the grip of second segment 18 in the direction of arrows 103, 105. Such tightening provides further control to the user during the installation of the tree step 14 and does not require the use of both of the user's hands, further enhancing the single-handed operation of the apparatus 10. Moreover, this feature permits insert 30 to adjust its grip of steps or hooks 14 of different diameters.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope of the general inventive concept.

What is claimed is:

1. A drill insert for coupling a step or hook to a structure, comprising:
a gripping portion configured to engage the step or hook; and
a supporting portion having an interior channel for slidably receiving said gripping portion, and an elongate end configured for insertion into the chuck of a drill and extending along a longitudinal axis, said gripping and supporting portions being slidable relative to one another along the longitudinal axis, with selective sliding motion between said gripping and supporting portions being effective to selectively lock and release the step or hook relative to said insert.

2. The drill insert of claim 1, further comprising:
a depression in one of said gripping or supporting portions; and
a détente selectively received within said depression for restricting movement of said gripping and supporting portions relative to one another.

3. The drill insert of claim 2, further comprising:
a biasing member urging said détente toward said depression.

4. The drill insert of claim 1, further comprising:
a retaining element in one of said gripping or supporting portions.

5. The drill insert of claim 4, further comprising:
a pair of spaced confronting surfaces in the other of said gripping or supporting portions, the extent of the sliding motion of said gripping and supporting portions relative to one another corresponding to engagement of said retaining element with said spaced confronting surfaces.

6. The drill insert of claim 4, wherein said retaining element is positioned so as to prevent decoupling of said gripping and supporting portions from one another.

7. The drill insert of claim 4, further comprising:
a ramp in the other of said gripping or supporting portions and positioned for engagement with said retaining element, movement of said retaining element along said ramp being effective to tighten the grip of the step or hook by said insert.

8. The drill insert of claim 4, wherein said retaining element is a pin extending along a pin axis, said pin axis being spaced from the longitudinal axis.

9. The drill insert of claim 1, wherein said gripping portion includes a first notch configured to receive the step or hook therein.

10. The drill insert of claim 9, wherein said first notch is oriented so as to receive the step or hook in a direction transverse to the longitudinal axis.

11. The drill insert of claim 9, wherein said supporting portion includes a second notch cooperating with said first notch to substantially surround a cross-section of the step or hook so as restrict movement of the step or hook, relative to said insert, in two directions along the longitudinal axis.

12. The drill insert of claim 11, wherein said supporting portion includes a third notch spaced from said second notch and cooperating with said first and second notches to restrict movement of the step or hook, relative to said insert, in a direction transverse to the longitudinal axis.

13. The drill insert of claim 1, wherein said insert is free of rotatable fasteners.

14. The drill insert of claim 1, wherein said insert is free of non-metallic components.

15. The drill insert of claim 1, further comprising:
a pin in said supporting portion and extending within said interior channel positioned to engage said gripping portion at spaced surfaces therein to prevent decoupling of said gripping and supporting portions from one another; and
a ramp in said gripping portion between said spaced surfaces and positioned for engagement with said pin, movement of said pin along said ramp being effective to tighten the grip of the step or hook by said insert.

16. The drill insert of claim 15, further comprising:
a depression in a surface of said interior channel of said supporting portion;
a détente in said gripping portion urged toward said surface of said interior channel by a biasing member, and engageable with said depression;
wherein said détente is adapted to restrict the sliding motion of said gripping and supporting portions when engaged in said depression.

17. An apparatus for coupling a step or hook to a structure, the apparatus comprising:
a drill having a chuck; and
an insert including a gripping portion configured to engage the step or hook, and a supporting portion having an interior channel for slidably receiving said gripping portion and an elongate end extending along a longitudinal axis and configured for insertion into said chuck, said gripping and supporting portions being slidable relative to one another along the longitudinal axis, with selective sliding motion between said gripping and supporting portions being effective to selectively lock and release the step or hook relative to said insert.

18. A method for coupling a step or hook to a structure, the method comprising:
coupling an elongate end of an insert into a chuck of a drill, the insert comprising a gripping portion and a supporting portion having the elongate end and an interior channel slidably receiving the gripping portion opposite the elongate end, the gripping portion being slidable along a longitudinal axis between an extended position and a retracted position;
engaging the step or hook in the gripping portion while in the extended position; and
sliding the gripping and supporting portions of the insert relative to one another to the retracted position to lock the step or hook relative to the insert.

19. The method of claim 18, wherein the gripping portion includes a ramp and the supporting portion includes a pin in the interior channel, the method further comprising:
moving the pin along the ramp to thereby tighten grip of the step or hook by the insert in a direction transverse to the longitudinal axis.

20. The method of claim 18, wherein the gripping portion includes an outwardly biased détente, and the supporting portion includes a depression, the method further comprising:
engaging the outwardly biased détente with the depression to thereby restrict slidable movement of the gripping and supporting portions relative to one another from the retracted position.
